(19) United States
(12) Patent Application Publication
(10) Pub. No.: US 2020/0250326 A1
(43) Pub. Date: Aug. 6, 2020

(54) Operation of an Electronic Device during Maintenance

(71) Applicant: Telefonaktiebolaget LM Ericsson (publ), Stockholm (SE)

(72) Inventors: José Araújo, Stockholm (SE); Ola Angelsmark, Ystad (SE); Per Persson, Södra Sandby (SE); Bernard Smeets, Dalby (SE)

(21) Appl. No.: 16/650,890

(22) PCT Filed: Oct. 25, 2017
(86) PCT No.: PCT/EP2017/077341

§ 371 Date: Mar. 26, 2020

(51) Int. Cl. G06F 21/62

(52) U.S. Cl. CPC G06F 21/6218

(57) ABSTRACT

There is provided mechanisms for operating an electronic device during maintenance. A method is performed by the electronic device. The method comprises detecting initiation of a maintenance operation to be executed on the electronic device. The method comprises, in response thereto, rendering a selected set of information stored in the electronic device inaccessible until detecting completion of the maintenance operation.

### TECHNICAL FIELD

Embodiments presented herein relate to a method, an electronic device, a computer program, and a computer program product for operating the electronic device during maintenance.

### BACKGROUND

Some electronic devices rely on software for their operation. In some cases the electronic devices themselves are controlled by software (and/or firmware) supplied by the manufacturer of the electronic devices, and the operations performed by the electronic devices are controlled by software (such as software applications) supplied by the user of the electronic devices. The manufacturer of the electronic devices might issue software (and/or firmware) upgrades, to be applied at the electronic devices. Further, software applications might be developed and deployed on the electronic devices by the user. Both firmware and software applications might be considered as pieces of privacy sensitive information and as trade secrets by their respective owners.

The same scenario is applicable when the electronic devices are subjected to repairs and/or maintenance. Typically, the owner of the electronic devices would physically hand over the electronic devices to a repair and/or maintenance agent performing such repairs and/or maintenance.

When the device manufacturer or the repair and/or maintenance agent accesses the electronic devices for maintenance they might be able to access, either deliberately or by accident, the software applications deployed by the user as well as user data stored in the electronic devices, thus gaining access to privacy sensitive information.

Hence, there is a need for improved handling of electronic devices during maintenance.

### SUMMARY

An object of embodiments herein is to provide efficient handling of electronic devices during maintenance that alleviates, or at least mitigates or reduces, the issues noted above.

According to a first aspect there is presented a method for operating an electronic device during maintenance. The method is performed by the electronic device. The method comprises detecting initiation of a maintenance operation to be executed on the electronic device. The method comprises, in response thereto, rendering a selected set of information stored in the electronic device inaccessible until detecting completion of the maintenance operation.

According to a second aspect there is presented an electronic device for operating the electronic device during maintenance. The electronic device comprises processing circuitry. The processing circuitry is configured to cause the electronic device to detect initiation of a maintenance operation to be executed on the electronic device. The processing circuitry is configured to cause the electronic device to, in response thereto, render a selected set of information stored in the electronic device inaccessible until detecting completion of the maintenance operation.

According to a third aspect there is presented an electronic device for operating the electronic device during maintenance. The electronic device comprises a detect module configured to detect initiation of a maintenance operation to be executed on the electronic device. The electronic device comprises a render module configured to, in response thereto, render a selected set of information stored in the electronic device inaccessible until detecting completion of the maintenance operation.

Advantageously this method, these electronic devices, this computer program and this computer program product provide efficient handling of the electronic devices during maintenance.

Advantageously this method, these electronic devices, this computer program and this computer program product alleviate, or at least mitigate or reduce, the issues noted above.

Advantageously this method, these electronic devices, this computer program and this computer program product enable protection of proprietary information, such as trade secrets or other privacy sensitive information of the user, in the electronic device, as well as guarantee the veracity of the electronic device supplier or maintenance entity.

According to a fourth aspect there is presented a computer program for operating an electronic device during maintenance, the computer program comprising computer program code which, when run on the electronic device, causes the electronic device to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communications system according to embodiments;

FIG. 2 is a flowchart of methods according to embodiments;

FIG. 3 is a schematic diagram showing functional units of an electronic device according to an embodiment;

FIG. 4 is a schematic diagram showing functional modules of an electronic device according to an embodiment;

FIG. 5 is a schematic diagram showing network equipment comprising an electronic device according to an embodiment;

FIG. 6 is a schematic diagram showing user equipment comprising an electronic device according to an embodiment; and

FIG. 7 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

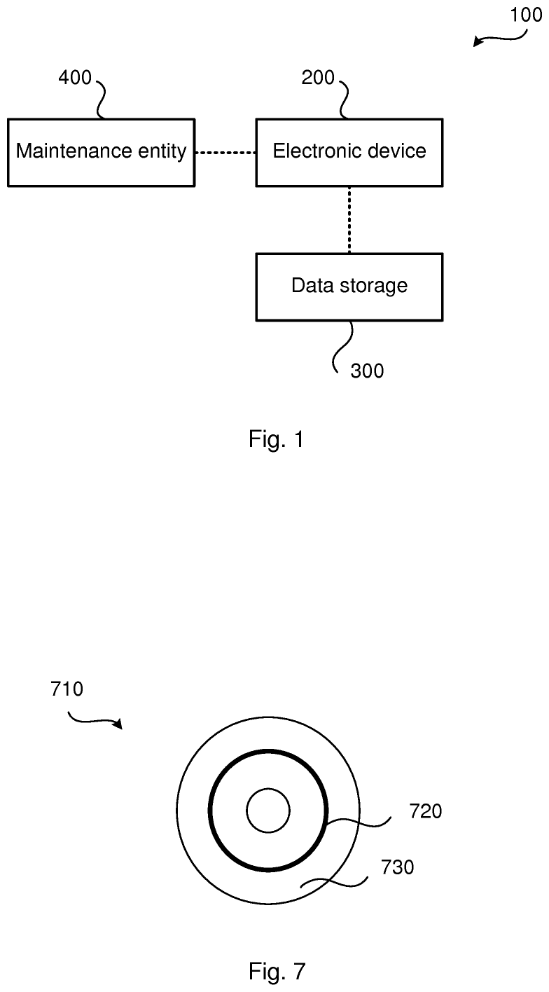

FIG. 1 is a schematic diagram illustrating a communications system 100 where embodiments presented herein can be applied. The communications system 100 comprises an electronic device 200, a data storage 300, and a maintenance entity 400. Dotted lines in FIG. 1 indicate operative connections. It is assumed that a maintenance operation is to be executed on the electronic device 200. The maintenance operation is initiated by the maintenance entity 400. As disclosed above there is a risk that privacy sensitive information, or other trade secrets, are accessed by the maintenance entity 400 during maintenance of the electronic device 200.

The embodiments disclosed herein therefore relate to mechanisms for operating the electronic device 200 during maintenance that alleviates, or at least mitigates or reduces, the issues noted above as would otherwise occur when maintenance of the electronic device 200 is performed. In order to obtain such mechanisms there is provided an electronic device 200, a method performed by the electronic device 200, a computer program product comprising code, for example in the form of a computer program, that when run on an electronic device 200, causes the electronic device 200 to perform the method.

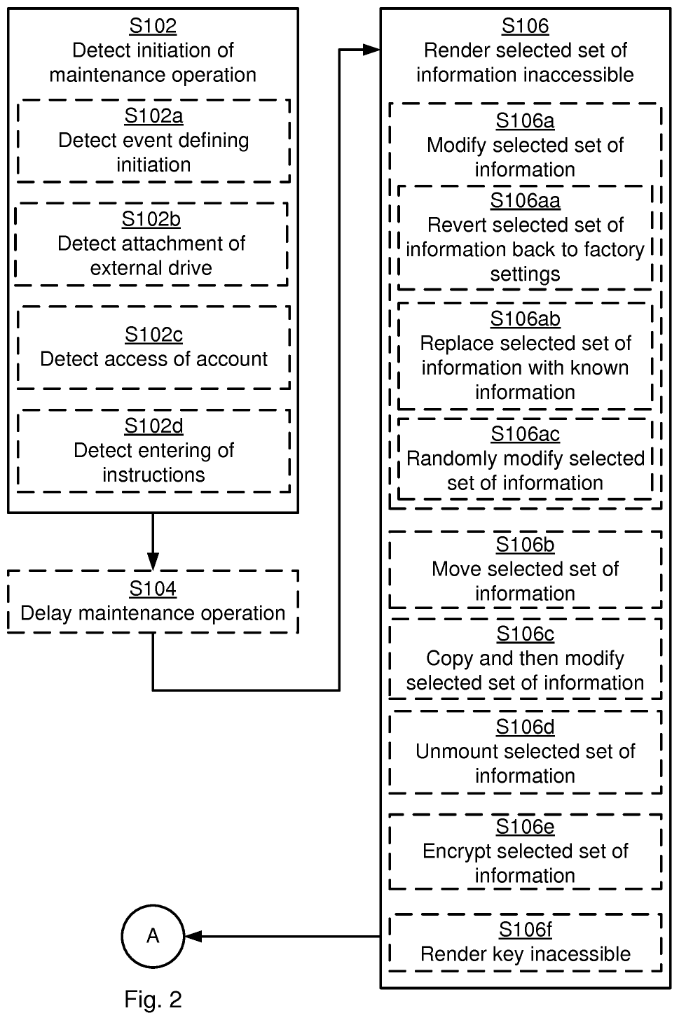

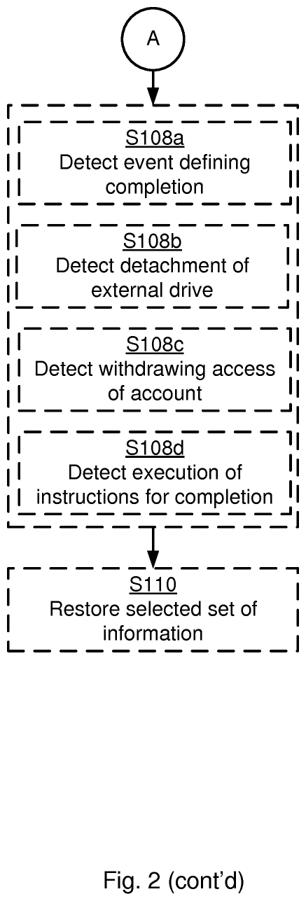

FIG. 2 is a flowchart illustrating embodiments of methods for operating the electronic device 200 during maintenance. The methods are performed by the electronic device 200. The methods are advantageously provided as computer programs 720.

It is assumed that maintenance is to be performed on the electronic device 200. Hence, the electronic device 200 is configured to perform step S102:

S102: The electronic device 200 detects initiation of a maintenance operation to be executed on the electronic device 200. Examples of how the initiation of the maintenance operation might be detected will be provided below.

In response to having detecting this initiation, the electronic device 200 hides information that is not to be accessed during the maintenance of the electronic device 200. Particularly, the electronic device 200 is configured to perform step S106:

S106: The electronic device 200, in response thereto (i.e. upon the detection in step S102), renders a selected set of information stored in the electronic device 200 inaccessible. The selected set of information is rendered inaccessible until detecting completion of the maintenance operation.

Examples of how the set of information might be rendered inaccessible will be provided below.

Steps S102 and S106 enable sensitive data to be hidden during maintenance of the electronic device 200.

Embodiments relating to further details of operating the electronic device 200 during maintenance as performed by the electronic device 200 will now be disclosed.

There might be different examples of maintenance performed on the electronic device 200. In some aspects the maintenance concerns upgrading software and/or firmware. That is, according to an embodiment, the maintenance operation relates to updating of at least one of software and firmware in the electronic device 200.

There might be different types of information in the selected set of information.

In general terms, the selected set of information might include anything not part of factory settings of the electronic device 200, and/or information explicitly labelled as privacy sensitive information. Examples include, but are not limited to, proprietary software and proprietary data (such as collected sensor data, etc.). That is, according to an embodiment, the selected set of information represents: proprietary software, data recordings made, or obtained by, the electronic device 200, and/or information labelled as privacy sensitive.

In more detail, in some embodiments, the selected set of information comprises algorithms and/or data which is located and used by the electronic device 200 to operate. One example of an algorithm is a control algorithm. In another example, the data is operation data collected by a sensor. In some embodiments, the selected set of information is identified as algorithms or data which are not part of the factory settings of the electronic device 200. In some embodiments, the selected set of information has been explicitly labeled as privacy sensitive information by a user of the electronic device 200.

There might be different ways for the electronic device 200 to detect initiation of the maintenance operation in step S102.

In some embodiments, an event is detected in the electronic device 200 which means that a maintenance operation is about to be performed. One example of such an event is the attachment of an external drive to the electronic device 200. For example, the electronic device 200 might detect that a universal serial bus (USB) drive is mounted to the electronic device 200. Another example of such an event is the connection to the electronic device 200 of a maintenance account, which means that a maintenance operation is about to be performed. Yet another example of such an event is the entering of a pre-determined maintenance code on the electronic device 200, signifying that a maintenance operation is about to be performed.

That is, according to an embodiment, the electronic device 200 is configured to perform any of (optional) steps S102a-S102d in order to detect the initiation of the maintenance operation:

S102a: The electronic device 200 detects an event defining initiation of the maintenance operation.

S102b: The electronic device 200 detects an external drive being attached to the electronic device 200.

S102c: The electronic device 200 detects a maintenance operation account accessing the electronic device 200.

S102d: The electronic device 200 detects maintenance operation instructions being entered into the electronic device 200 for execution therein.

Any of steps S102a-S102d could be performed as part of step S102.

There might be different ways for the electronic device 200 to act once having detected the initiation of the maintenance operation in step S102.

In some aspects the maintenance operation is delayed until information has been hidden. Particularly, according to an embodiment, the electronic device 200 is configured to perform (optional) step S104:

S104: The electronic device 200 delays execution of the maintenance operation in the electronic device 200 until the selected set of information has been rendered inaccessible.

There might be different ways for the electronic device 200 to render the render the selected set of information inaccessible in step S106, for example in order to prevent the maintenance entity 400 from accessing privacy sensitive information during maintenance of the electronic device 200.

In some aspects, information in the electronic device 200 is made inaccessible to signals generated by the maintenance operation. That is, according to an embodiment, the maintenance operation comprises executing a set of maintenance operation instructions. The set of maintenance operation instructions generates a set of signals to be applied in the electronic device 200. The selected set of information is then rendered inaccessible for the set of signals.

In aspects, the electronic device 200 modifies the selected set of information in the electronic device 200. Examples of such modifications will be provided below.

In some aspects, using cryptographic keys stored on dedicated secure storage medium, or on the electronic device 200 itself, the electronic device 200 might establish a connection to a data storage 300 external to the electronic device 200. If the secure connection to the data storage 300 is established, the selected set of information might be moved to the data storage 300, and the medium comprising the cryptographic keys is removed and/or unmounted from the electronic device 200. In some embodiments, the selected set of information is thus transmitted to a data storage 300 and removed from the electronic device 200. This is suitable if the electronic device 200 does not have to operate during execution of the maintenance operation. In some embodiments, the selected set of information is transmitted to the data storage 300 and the selected set of information is modified in the electronic device 200. In this way, the electronic device 200 may still operate during execution of the maintenance operation. However, if such a secure connection cannot be established, or if the data storage 300 for some other reason rejects the connection to be established, the maintenance operation is not allowed and the execution of the maintenance operation is rejected or postponed until the electronic device 200 has render the selected set of information inaccessible in another way.

In some aspects, the selected set of information is allowed to be moved to the data storage 300 without the need to establish a secure connection. This could be the case if the electronic device 200 has authenticated the data storage 300.

In some aspects, the selected set of information is stored on a drive in the electronic device 200. The drive on which the selected set of information is stored might then be unmounted from the electronic device 200. This prevents the maintenance entity 400 from accessing the selected set of information.

In some aspects, the selected set of information is encrypted in response to detecting the initiation of the maintenance operation in step S102. This prevents the maintenance entity 400 from accessing the selected set of information, although the maintenance entity 400 might copy the thus encrypted selected set of information.

In some aspects, the selected set of information is already encrypted when the initiation of the maintenance operation is detected in step S102. The electronic device 200 might then hide a key for decrypting the selected set of information from the maintenance entity 400. This prevents the maintenance entity 400 from accessing the selected set of information, although the maintenance entity 400 might copy the thus encrypted selected set of information.

That is, according to an embodiment, the electronic device 200 is configured to perform any of (optional) steps S106a-S106f in order to render the selected set of information inaccessible:

S106a: The electronic device 200 modifies the selected set of information in the electronic device 200.

S106b: The electronic device 200 moves the selected set of information to a data storage 300 external to the electronic device 200.

S106c: The electronic device 200 copies the selected set of information to the data storage 300 external to the electronic device 200 and modifies the selected set of information in the electronic device 200.

S106d: The electronic device 200 unmounts a drive on the electronic device 200, on which drive the selected set of information is stored.

S106e: The electronic device 200 encrypts the selected set of information.

S106f: The electronic device 200 renders a key for decrypting the selected set of information inaccessible.

Any of steps S106a-S106f could be performed as part of step S106.

The data storage 300 might be located on a secure server which may be located on-site or off-site relative the electronic device 200.

As noted above, in some aspects the selected set of information is moved or copied to the data storage 300 over a secure connection. Particularly, according to an embodiment, when the selected set of information is moved or copied to the data storage 300 external to the electronic device 200, the selected set of information is communicated over a secured communications channel to the data storage 300 external to the electronic device 200.

There might be different ways for the electronic device 200 to modify the selected set of information in step S106a

In some embodiments, the modification of the selected set of information comprises replacing proprietary software with original factory software.

In some embodiments, the modification of the selected set of information comprises replacing proprietary software by basic and known software. In some embodiments, proprietary software is randomly modified. The same procedure may be applied to data stored in the electronic device 200.

Particularly, according to an embodiment, the electronic device 200 is configured to perform any of (optional) steps S106aa-S106ac in order to modify the selected set of information:

S106aa: The electronic device 200 reverts the selected set of information back to factory settings.

S106ab: The electronic device 200 replaces the selected set of information with information and/or settings known to the maintenance entity 400 initiating the maintenance operation.

S106ac: The electronic device 200 randomly modifies the selected set of information.

Any of steps S106aa-S106ac could be performed as part of step S106a.

There might be different ways for the electronic device 200 to detect completion of the maintenance operation. In general terms, how to detect completion of the maintenance operation is dependent on how the detect the initiation of the maintenance operation was detected in step S102.

For example, if the electronic device 200 detects an event defining initiation of the maintenance operation (as in step S102a), the electronic device 200 might detect another event defining completion of the maintenance operation.

Thus, in some embodiments, an event is detected in the electronic device 200 which means that the maintenance operation has been completed. One example of such an event is the detachment of an external drive from the electronic device 200. For example, the electronic device 200 might detect that a USB drive is unmounted from the electronic device 200. Another example of such an event is the disconnection of a maintenance account, which means that a maintenance operation has been completed. Yet another example of such an event is the completion of execution of pre-determined maintenance code on the electronic device 200, signifying that the maintenance operation is has been completed.

According to an embodiment, the electronic device 200 is configured to perform any of (optional) steps S108a-S108d to detect completion of the maintenance operation:

S108a: The electronic device 200 detects an event defining completion of the maintenance operation.

S108b: The electronic device 200 detects an external drive being detached from the electronic device 200.

S108c: The electronic device 200 detects a maintenance operation account withdrawing from accessing the electronic device 200.

S108d: The electronic device 200 detects maintenance operation instructions for completion of the maintenance operation being executed in the electronic device 200.

There might be different ways for the electronic device 200 to act upon completion of the maintenance operation.

In general terms, the objective is to again render the selected set of information accessible and thus to return the selected set of information to its state before the initiation of the maintenance operation was detected. How to act might thus depend on how the selected set of information was rendered inaccessible in step S106.

In some aspects, the selected set of information is again rendered accessible by the electronic device 200 performing the reversal of the operations for rendering the set of information inaccessible.

In some embodiments, the selected set of information stored at the data storage 300 is transmitted from the data storage 300 to the electronic device 200 for again being utilized by the electronic device 200.

Thus, in some aspects where the selected set of information is transmitted to the data storage 300 over a secure connection in step S106, the electronic device 200 might use cryptographic keys stored on dedicated secure storage medium, or on the electronic device 200 itself, to establish a new connection to the data storage 300 for transmission of the selected set of information back to the electronic device 200. However, if such a new secure connection cannot be established, or if the data storage 300 for some other reason rejects the connection to be established, the selected set of information might not be transmitted back to the electronic device 200.

Thus, in some aspects where the selected set of information is transmitted to the data storage 300 over a non-secure connection in step S106, the selected set of information back to the electronic device 200 might be transmitted back to the electronic device 200 without the use of cryptographic keys.

In some embodiments where a modified version of the selected set of information has been stored in the electronic device 200 whilst an original (i.e. unmodified) selected set of information has been moved to the data storage 300, the thus modified selected set of information in the electronic device 200 is removed from the electronic device 200 once the original selected set of information is received back from the data storage 300.

Thus, in some aspects where the selected set of information is modified in the electronic device 200 in step S106, the selected set of information is restored in the electronic device 200. Such a restoration is possible by using a mapping between the original selected set of information and the modified selected set of information, further assuming that the modification is not defined by a one way function.

Particularly, according to an embodiment, the electronic device 200 is configured to perform (optional) step S10:

S110: The electronic device 200 restores the selected set of information, upon completion of the maintenance operation, to its state in the electronic device 200 before initiation of the maintenance operation.

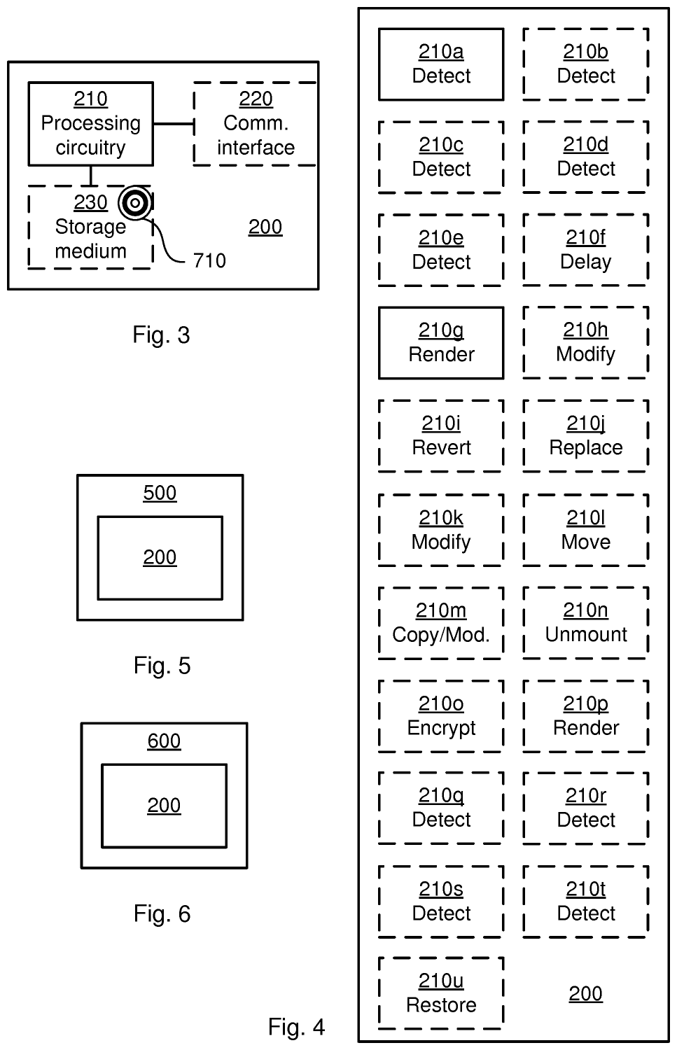

Further aspects of the electronic device 200 will be disclosed below with reference to FIGS. 3, 4, 5, and 6.

Further aspects of the data storage 300 will now be disclosed.

The storage on the data storage 300 might be a common-purpose data storage. However, in some aspects the data storage 300 is aware of the maintenance cycle. This allows for the data storage 300 to be configured to perform further actions to protect the selected set of information (besides rejection due to invalid cryptographic keys, etc.).

For example, during initiation of the maintenance operation, the data storage 300 might receive and store the selected set of information and then set state information in the data storage 300 to indicate that a maintenance operation is underway.

For example, during initiation of the maintenance operation, the data storage 300 might reject the request for a secure connection if state information in the data storage 300 indicates that a maintenance operation of the electronic device 200 is already ongoing. The data storage 300 might then also indicate this to the electronic device 200.

For example, during execution of the maintenance operation and when state information in the data storage 300 thus indicates that a maintenance operation of the electronic device 200 is already ongoing, the data storage 300 might reject receiving a new piece of selected set of information. The data storage 300 might then also indicate this to the electronic device 200.

For example, upon completion of the maintenance operation, the data storage 300 might transmit the selected set of information back to the electronic device 200 and then set state information in the data storage 300 to indicate that a maintenance operation is completed (or that a maintenance operation is not currently performed).

For example, upon completion of the maintenance operation and when the state information in the data storage 300 indicates that a maintenance operation is completed (or that a maintenance operation is not currently performed), the data storage 300 might, when there is not any scheduled maintenance operation, reject a request to receive a new piece of selected set of information. The data storage 300 might then also indicate this to the electronic device 200.

In view of the above, the data storage 300 might be configured to perform data storage of the selected set of information as transmitted to the data storage 300 from the electronic device 200, to transmit the selected set of information back to the electronic device 200 when requested to do so, to prevent access to the selected set of information from non-authorized entities, and to (optionally) be aware of the maintenance cycle of the electronic device 200 in order to proactively enable data integrity.

FIG. 3 schematically illustrates, in terms of a number of functional units, the components of an electronic device 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7), e.g. in the form of a storage medium 230. The processing circuitry 210 may further be provided as at least one application specific integrated circuit (ASIC), or field programmable gate array (FPGA).

Particularly, the processing circuitry 210 is configured to cause the electronic device 200 to perform a set of operations, or steps, S102-S110, as disclosed above. For example, the storage medium 230 may store the set of operations, and the processing circuitry 210 may be configured to retrieve the set of operations from the storage medium 230 to cause the electronic device 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The electronic device 200 may further comprise a communications interface 220 at least configured for communications with other entities, functions, nodes, drives, and devices, such as the data storage 300 and the maintenance entity 400. As such the communications interface 220 may comprise one or more transmitters and receivers, comprising analogue and digital components. The processing circuitry 210 controls the general operation of the electronic device 200 e.g. by sending data and control signals to the communications interface 220 and the storage medium 230, by receiving data and reports from the communications interface 220, and by retrieving data and instructions from the storage medium 230. Other components, as well as the related functionality, of the electronic device 200 are omitted in order not to obscure the concepts presented herein.

FIG. 4 schematically illustrates, in terms of a number of functional modules, the components of an electronic device 200 according to an embodiment. The electronic device 200 of FIG. 4 comprises a number of functional modules; a detect module 210a configured to perform step S102, and a render module 210g configured to perform step S106. The electronic device 200 of FIG. 4 may further comprise a number of optional functional modules, such as any of a detect module 210b configured to perform step S102a, a detect module 210c configured to perform step S102b, a detect module 210d configured to perform step S102c, a detect module 210e configured to perform step S102d, a delay module 210f configured to perform step S104, a modify module 210h configured to perform step S106a, a revert module 210i configured to perform step S106aa, a replace module 210j configured to perform step S106ab, a modify module 210k configured to perform step S106ac, a move module 210l configured to perform step S106b, a copy and modify module 210m configured to perform step S106c, an unmount module 210n configured to perform step S106d, an encrypt module 2100 configured to perform step S106e, a render module 210p configured to perform step S106f, a detect module 210q configured to perform step S108a, a detect module 210r configured to perform step S108b, a detect module 210S configured to perform step S108c, a detect module 210t configured to perform step S108d, and a restore module 210u configured to perform step S10.

In general terms, each functional module 210a-210u may in one embodiment be implemented only in hardware and in another embodiment with the help of software, i.e., the latter embodiment having computer program instructions stored on the storage medium 230 which when run on the processing circuitry makes the electronic device 200 perform the corresponding steps mentioned above in conjunction with FIG. 4. It should also be mentioned that even though the modules correspond to parts of a computer program, they do not need to be separate modules therein, but the way in which they are implemented in software is dependent on the programming language used. Preferably, one or more or all functional modules 210a-210u may be implemented by the processing circuitry 210, possibly in cooperation with the communications interface 220 and/or the storage medium 230. The processing circuitry 210 may thus be configured to from the storage medium 230 fetch instructions as provided by a functional module 210a-210u and to execute these instructions, thereby performing any steps as disclosed herein.

The electronic device 200 may be provided as a standalone device or as a part of at least one further device. For example, the electronic device 200 may be provided in network equipment or in user equipment. FIG. 5 is a schematic diagram showing network equipment 500 comprising an electronic device 200 according to an embodiment. Examples of network equipment include, but are not limited to, radio access network nodes, functions, entities, and devices as well as core network nodes, functions, entities, and devices. FIG. 6 is a schematic diagram showing user equipment 600 comprising an electronic device 200 according to an embodiment. Examples of user equipment include, but are not limited to, wireless devices, mobile stations, mobile phones, handsets, wireless local loop phones, user equipment (UE), smartphones, laptop computers, tablet computers, network equipped vehicles, network equipped sensors, and Internet of things (IoT) devices.

Further, the functionality of the electronic device 200 may be distributed between at least two such nodes, functions, entities, or devices. Thus, a first portion of the instructions performed by the electronic device 200 may be executed in a first device, and a second portion of the of the instructions performed by the electronic device 200 may be executed in a second device; the herein disclosed embodiments are not limited to any particular number of devices on which the instructions performed by the electronic device 200 may be executed. Hence, the methods according to the herein disclosed embodiments are suitable to be performed by an electronic device 200 residing in a cloud computational environment. Therefore, although a single processing circuitry 210 is illustrated in FIG. 3 the processing circuitry 210 may be distributed among a plurality of devices, or nodes. The same applies to the functional modules 210a-210u of FIG. 4 and the computer program 720 of FIG. 7 (see below).

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1.-27. (canceled)

28. A method for operating an electronic device to prevent access to privacy-sensitive information during maintenance, the method being performed by the electronic device and comprising:
detecting initiation of a maintenance operation to be executed on the electronic device; and
in response to detecting the initiation, rendering a selected set of information stored in the electronic device inaccessible until completion of the maintenance operation.

29. The method according to claim 28, wherein the detecting initiation of the maintenance operation comprises detecting at least one of the following:
an event defining initiation of the maintenance operation,
an external drive being attached to the electronic device,
a maintenance operation account accessing the electronic device, and
maintenance operation instructions being entered into the electronic device for execution therein.

30. The method according to claim 28, further comprising delaying execution of the maintenance operation in the electronic device until the selected set of information has been rendered inaccessible.

31. The method according to claim 28, further comprising detecting completion of the maintenance operation based on detecting at least one of the following:
an event defining completion of the maintenance operation,
an external drive being detached from the electronic device,
a maintenance operation account withdrawing from accessing the electronic device, and
maintenance operation instructions for completion of the maintenance operation being executed in the electronic device.

32. The method according to claim 28, wherein:
the maintenance operation comprises executing a set of maintenance operation instructions for generating a set of signals to be applied in the electronic device, and
the selected set of information is rendered inaccessible for the set of signals.

33. The method according to claim 28, wherein rendering the selected set of information inaccessible comprises at least one of the following:
modifying the selected set of information in the electronic device,
moving the selected set of information to a data storage external to the electronic device,
copying the selected set of information to the data storage external to the electronic device while modifying the selected set of information in the electronic device,
unmounting a drive on the electronic device, on which drive the selected set of information is stored,
encrypting the selected set of information, and
rendering a key for decrypting the selected set of information inaccessible.

34. The method according to claim 33, wherein when the selected set of information is moved or copied to the data storage external to the electronic device, the selected set of information is moved or copied via a secured communications channel.

35. The method according to claim 33, wherein when the selected set of information is modified, the selected set of information is modified by at least one of the following operations:
reverting the selected set of information back to factory settings,
replacing the selected set of information with information and/or settings known to a maintenance entity that initiates the maintenance operation, and
randomly modifying the selected set of information.

36. The method according to claim 28, further comprising, upon completion of the maintenance operation, restoring the selected set of information to its state in the electronic device before initiation of the maintenance operation.

37. The method according to claim 28, wherein the selected set of information includes or represents at least one of the following:
proprietary software,
data recordings made or obtained by the electronic device, and
information labelled as privacy sensitive.

38. The method according to claim 28, wherein the maintenance operation relates to updating of at least one of software and firmware in the electronic device.

39. An electronic device arranged to prevent access to privacy-sensitive information during maintenance, the electronic device comprising processing circuitry configured to cause the electronic device to:
detect initiation of a maintenance operation to be executed on the electronic device; and
in response to detection of the initiation, render a selected set of information stored in the electronic device inaccessible until completion of the maintenance operation.

40. The electronic device according to claim 39, wherein the electronic device is configured to detect initiation of the maintenance operation based on the processing circuitry being configured to detect one or more of the following:
an event defining initiation of the maintenance operation
an external drive being attached to the electronic device,
a maintenance operation account accessing the electronic device, and/or
maintenance operation instructions being entered into the electronic device for execution therein.

41. The electronic device according to claim 39, wherein the processing circuitry further is configured to cause the electronic device to delay execution of the maintenance operation in the electronic device until the selected set of information has been rendered inaccessible.

42. The electronic device according to claim 39, wherein the electronic device is configured to detect completion of the maintenance operation based on the processing circuitry being configured to detect one or more of the following:
an event defining completion of the maintenance operation,
an external drive being detached from the electronic device,
a maintenance operation account withdrawing from accessing the electronic device, and/or
maintenance operation instructions for completion of the maintenance operation being executed in the electronic device.

43. The electronic device according to claim 39, wherein:
the maintenance operation comprises executing a set of maintenance operation instructions for generating a set of signals to be applied in the electronic device; and
the selected set of information is rendered inaccessible for the set of signals.

44. The electronic device according to claim 39, wherein the electronic device is configured to render the selected set of information inaccessible based on the processing circuitry being configured to perform one or more of the following operations:
modify the selected set of information in the electronic device,
move the selected set of information to a data storage external to the electronic device,
copy the selected set of information to the data storage external to the electronic device while modifying the selected set of information in the electronic device,
unmount a drive on the electronic device, on which drive the selected set of information is stored,
encrypt the selected set of information, and
render a key for decrypting the selected set of information inaccessible.

45. The electronic device according to claim 44, wherein the processing circuitry is further configured to move and/or copy the selected set of information to the data storage external to the electronic device via a secured communications channel.

46. The electronic device according to 44, wherein the processing circuitry is further configured to modify the selected set of information in the electronic device based on one or more of the following operations:
revert the selected set of information back to factory settings,
replace the selected set of information with information and/or settings known to a maintenance entity that initiates the maintenance operation, and
randomly modify the selected set of information.

47. The electronic device according to claim 39, wherein the processing circuitry further is configured to cause the electronic device to, upon completion of the maintenance operation, restore the selected set of information to its state in the electronic device before initiation of the maintenance operation.

48. The electronic device according to claim 39, wherein the selected set of information includes or represents at least one of the following:
proprietary software,
data recordings made or obtained by the electronic device, and
information labelled as privacy sensitive.

49. The electronic device according to claim 39, wherein the maintenance operation relates to updating of at least one of software and firmware in the electronic device.
